(19) United States
(12) Patent Application Publication
(10) Pub. No.: US 2008/0094335 A1
(43) Pub. Date: Apr. 24, 2008

(54) LIQUID CRYSTAL DISPLAY AND METHOD OF DRIVING THE SAME

(75) Inventors: Joo Hwan KIM, Asan-Si (KR); Cheal Gi KIM, Yongin-Si (KR); Yong Jin SHIN, Asan-Si (KR)

Correspondence Address: CANTOR COLBURN, LLP, 20 Church Street, 22nd Floor, Hartford, CT, 06103, US

(73) Assignee: SAMSUNG ELECTRONICS CO., LTD.,, Suwon-si (KR)

(21) Appl. No.: 11/876,948

(22) Filed: Oct. 23, 2007

(30) Foreign Application Priority Data
Oct. 23, 2006 (KR) 1020060102951
Jul. 24, 2007 (KR) 1020070074175

(51) Int. Cl. G09G 3/14

(52) U.S. Cl. 345/89

(57) ABSTRACT

Disclosed are a liquid crystal display and a method of driving the same. The liquid crystal display includes a liquid crystal display panel displaying an image; a gate driver applying gate signals to the liquid crystal display panel; a data driver applying data signals to the liquid crystal display panel; and a signal controller controlling the gate driver and the data driver. The signal controller includes a control signal generating unit multiplying a frame rate, and an image signal processing unit correcting image data of each of multiplied frames by alternately using a plurality of correction data set having different correction characteristics.

This application claims priority to Korean Patent Application Nos. 10-2006-0102951, filed on Oct. 23, 2006 and 10-2007-0074175, filed on Jul. 24, 2007, and all the benefits accruing therefrom under 35 U.S.C. § 119, the contents of which in its entirety are herein incorporated by reference.

### BACKGROUND OF THE INVENTION

1. Field of the Invention

The present invention relates to a liquid crystal display and a method of driving the same, and in particular, to a liquid crystal display that can realize uniform visibility regardless of the position of a user, and to a method of driving the same.

2. Description of the Related Art

Liquid crystal displays “LCDs” are one type of display devices that display images by adjusting transmittance of light emitted from a light source using optical anisotropy of liquid molecules and polarization characteristics of a polarizing plate. The liquid crystal displays are lightweight and thin and have high resolution even with a large screen. The liquid crystal displays have low power consumption and have been increasingly used for various purposes.

In the liquid crystal displays, since light passes through only transmission axes of the liquid crystal molecules to display images, a viewing angle is comparatively narrow as compared with other display devices. As a result, various technologies have been studied to improve the viewing angle. Among the technologies, in a Patterned Vertically Aligned “PVA” mode, the liquid crystal molecules are vertically aligned with respect to upper and lower substrates. Further, cutout patterns or protrusion patterns are formed in a pixel electrode and a common electrode facing the pixel electrode. An electric field generated between the pixel electrode and the common electrode is distorted, thereby forming a plurality of domains, which improves the viewing angle.

In a Super Patterned Vertically Aligned “SPVA” mode that has been recently developed, a main pixel and a sub pixel that have different voltages from each other are formed in a unit pixel, and transmission axes of liquid crystal molecules are changed by domains, thereby improving the viewing angle.

With the development of various technologies, the viewing angle is improved; however, there still remains an issue with respect to visibility, specifically, lateral visibility, which is an important factor in determining display quality of the liquid crystal display. That is, an image to be displayed on the screen may undergo small vertical or horizontal color deformation due to a narrow viewing angle, which is a problem inherent in liquid crystal displays. Since the degree of color deformation changes according to the position of the user with respect to the screen, image quality as recognized by the user (i.e., visibility) varies. For example, viewing angles relative to a right side and a left side of the screen of the liquid crystal display are different based upon the position of the user at the screen. That is, since the image characteristics of the right side and the left side of the screen are different due to the color deformation, the user's visibility relative to both sides of the screen varies. The defect in visibility is worse on the right and left sides of the screen than it is at the upper and lower sides of the screen, and this is particularly true with larger screens.

### BRIEF SUMMARY OF THE INVENTION

Aspects of the present invention provide a liquid crystal display and a method of driving the same, in which an output frame rate of image signals is multiplied and image data of each of multiplied frames is corrected by alternately using a plurality of correction data set having different correction characteristics depending on viewing positions of a user with respect to the liquid crystal display to achieve uniform visibility regardless of the viewing position.

According to an exemplary embodiment of the present invention, a liquid crystal display includes: a liquid crystal display panel displaying an image; a gate driver applying gate signals to the liquid crystal display panel; a data driver applying data signals to the liquid crystal display panel; and a signal controller controlling the gate driver and the data driver. The signal controller includes a control signal generating unit multiplying a frame rate, and an image signal processing unit correcting image data of each of multiplied frames by alternately using a plurality of correction data set having different correction characteristics.

The liquid crystal display may further include a memory unit storing the plurality of the correction data set.

The correction characteristic of the plurality of correction data set may be changed depending on viewing positions of a user with respect to the liquid crystal display.

The plurality of correction data set may include a first look up table including correction data for providing an optimum image for a user viewing the liquid crystal display from the left side, and a second look-up table including correction data for providing an optimum image for a user viewing the liquid crystal display from the right side.

The correction data may include one of adaptive color capture data, dynamic capacitance compensation correction data, gamma compensation data and combinations thereof.

The first and the second look up tables may be alternately selected in accordance with a selection signal and provided to the image signal processing unit.

The selection signal may be generated based on a vertical sync start signal generated in the control signal generating unit.

The image signal processing unit may include one of an adaptive color capture circuit, a dynamic capacitance compensation circuit, a gamma compensation circuit and combinations thereof.

The control signal generating unit may double the frame rate from 60 Hz to 120 Hz.

According to another exemplary embodiment of the present invention, a method of driving a liquid crystal display includes: multiplying a frame rate to multiply the number of frames; correcting image data of each of multiplied frames by alternately using a plurality of correction data set having different correction characteristic; displaying an image by supplying the corrected image data to a liquid crystal display panel.

The correction characteristic of the plurality of correction data set may be changed depending on viewing positions of a user with respect to the liquid crystal display.

The plurality of correction data set may include a first look up table including correction data for providing an optimum image for a user viewing the liquid crystal display from the left side, and a second look up table including correction data for providing an optimum image for a user viewing the liquid crystal display from the right side.

According to the exemplary embodiment of the present invention, correcting the image data of each of the multiplied frames may include: correcting the image data using the first look up table in Nth frame; and correcting the image data using the second look up table in (N+1)th frame.

The correction of the image data may include one of an adaptive color capture mode, a dynamic capacitance compensation mode, a gamma compensation mode and combinations thereof.

The frame rate may be doubled from 60 Hz to 120 Hz.

### BRIEF DESCRIPTION OF THE DRAWINGS

The above and other aspects, features, and advantages of the present invention will become more apparent by describing in detail exemplary embodiments thereof with reference to the attached drawings in which:

FIG. 1 is a block diagram showing a liquid crystal display according to an exemplary embodiment of the invention;

FIG. 2 is a detailed block diagram of a signal controller and a memory unit in FIG. 1;

FIG. 3 is a schematic diagram illustrating correction data set alternately applied to respective frames;

FIGS. 4A and 4B are schematic diagrams illustrating visibility characteristics of an output image in each frame.

### DETAILED DESCRIPTION OF THE INVENTION

Hereinafter, an embodiment of the invention will be described with reference to the accompanying drawings. The present invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” other elements or features would then be oriented “above” or “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

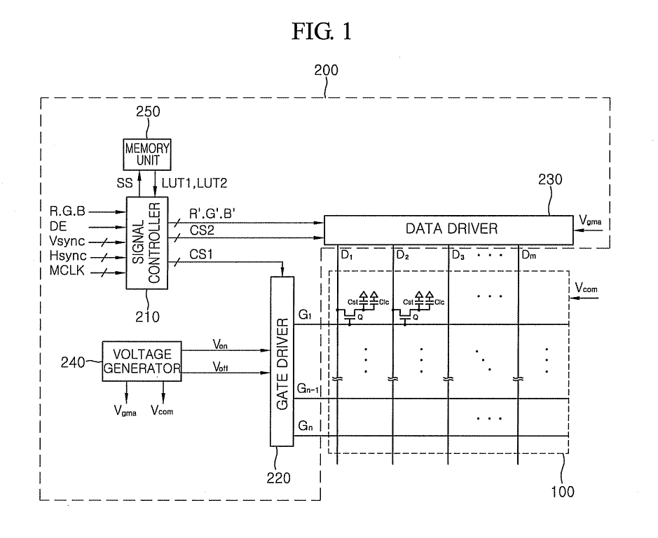

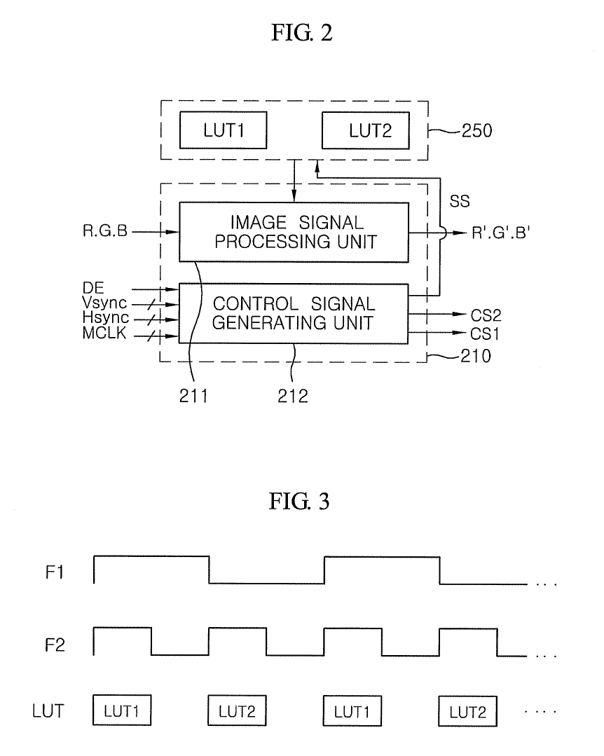

FIG. 1 is a block diagram showing a liquid crystal display according to an exemplary embodiment of the invention. FIG. 2 is a detailed block diagram of a signal controller and a memory unit in FIG. 1. Referring to FIG. 1, the liquid crystal display includes a liquid crystal display panel 100 that displays images and a driving circuit 200 that controls the operation of the liquid crystal display panel 100.

The liquid crystal display panel 100 includes a plurality of unit pixels that are arranged in a matrix shape. The unit pixels are respectively at intersections of a plurality of gate lines G1 to Gn substantially extending in a row direction and a plurality of data lines D1 to Dm substantially extending in a column direction. Each of the unit pixels includes a switching element Q, and a liquid crystal capacitor Clc and a storage capacitor Cst that are connected to the switching element Q. Though not shown in FIG. 1, the liquid crystal display panel 100 includes a lower substrate, on which the switching elements Q, the gate lines G, the data lines D, and pixel electrodes are arranged, an upper substrate, on which a black matrix, color filters, and a common electrode are arranged, and a liquid crystal layer interposed between the two substrates.

The driving circuit 200 includes a memory unit 250, a signal controller 210, a voltage generator 240, a gate driver 220 and a data driver 230 and is provided outside the liquid crystal display panel 100.

The gate driver 220 and the data driver 230 may be mounted on the lower substrate of the liquid crystal display panel 100 or may be mounted on an additional printed circuit board (PCB) and electrically connected to the liquid crystal display panel 100 through a flexible printed circuit board (FPC). In an embodiment, the gate driver 220 and the data driver 230 is mounted in the form of one or more driving chips. In a further embodiment, the signal controller 210 and the voltage generator 240 are mounted on the PCB and electrically connected to the liquid crystal display panel 100 through the FPC.

The memory unit 250 stores a plurality of correction data set having different correction characteristics depending on viewing positions of a user with respect to the liquid crystal display. Each correction data set may be stored in a form of a look up table (LUT). For example, the memory unit 250 stores a first look up table LUT1 optimized for the user viewing the screen from the left side, and a second look up table LUT2 optimized for the user viewing the screen from the right side. The correction data may be one of adaptive color capture (ACC) data for minimizing a deviation of color coordinates among gray levels, dynamic capacitance compensation (DCC) data for determining maximum value of response speed among gray levels, gamma data for controlling gamma characteristic and combinations thereof. Further, the memory unit 250 alternately selects the first look up table LUT1 or the second look up table LUT2 according to a selection signal SS from the signal controller 210, and supplies the selected look up table to the signal controller 210. The selection signal SS is generated based on a vertical sync start signal STV. Thus, the first look up table LUT1 is selected and supplied to the signal controller 210 in an Nth frame, and the second look up table LUT2 is selected and supplied to the signal controller 210 in an (N+1)th frame. Here, N is a positive integer. The memory unit 250 may use an electrically erasable and programmable read only memory (EEPROM). Further, various look up tables for generating various control signals can also be stored in the memory unit 250 other than the aforementioned look up tables LUT1 and LUT2. In addition, although the memory unit 250 is disposed outside the signal controller 210 in the exemplary embodiment, it can be provided inside the signal controller 210.

The signal controller 210 includes an image signal processing unit 211 and a control signal generating unit 212. The signal controller 210 receives an external image signal and an external control signal from an external graphic controller (not shown), and receives various look up tables from the memory unit 250. Then the signal controller 210 generates internal image data R′, G′, and B′ and internal control signals suitable for an operational condition of the liquid crystal display panel 100.

The image signal processing unit 211 generates an internal image data R′, G′ and B′ by processing an external image data R, G and B to be suitable for an operational condition of the liquid crystal display panel 100. In this way, the internal image data R′, G′ and B′ are converted to digital type, and rearranged according to a pixel arrangement of the liquid crystal display panel 100. And the image characteristic is corrected. The image correction may be performed by various modes such as ACC mode, DCC mode, gamma compensation mode and the like. Accordingly, the image signal processing unit 211 may include at least one image correction circuits such as ACC circuit, DCC circuit, gamma compensation circuit and the like.

The control signal generating unit 212 generates a gate control signal CS1 for controlling the operation of the gate driver 220, and a data control signal CS2 for controlling the operation of the data driver 230 based on external input control signals, that is, a vertical sync signal Vsync, a horizontal sync signal Hsync, a main clock MCLK, a data enable signal DE etc. Further, the control signal generating unit 212 transmits the gate control signal CS1 to the gate driver 220, and transmits the data control signal CS2 to the data driver 230. The gate control signal CS1 includes: a vertical sync start signal STV instructing the start of the output of the gate on voltage Von; a gate clock signal CPV; and an output enable signal OE. The data control signal CS2 includes: a horizontal sync start signal STH indicating start of transmission of the image data R′, G′ and B′; a load signal LOAD instructing supply of the data signal to a corresponding data line; an inversion signal RVS for reversing a polarity of a gray scale voltage with respect to a common voltage; and a data clock signal DCLK. In particular, the control signal generating unit 212 according to the exemplary embodiment can generate the gate control signal CS1 and the data control signal CS2 by increasing the frame rate to be doubled while correcting the external image data R, G and B. Accordingly, an operation clock frequency of the vertical sync start signal STV, by which the respective frames are identified, is doubled from 60 Hz to 120 Hz, so that twice as many frames are displayed during the same period. And the control signal generating unit 212 generates the selection signal SS based on the vertical sync start signal STV, by which the respective frames are identified, and transmits the selection signal SS to the memory unit 250.

The voltage generator 240 generates and outputs a plurality of driving voltages for driving the liquid crystal display using an external power input from an external power supply device (not shown). For example, the voltage generator 240 generates a gate-on voltage “Von” for turning on the switching element Q and a gate-off voltage “Voff” for turning off the switching element Q, and outputs the gate-on voltage Von and the gate-off voltage Voff to the gate driver 220. Further, the voltage generator 240 generates a grayscale voltage “Vgma” having a plurality of levels to be applied to the pixel electrode (not shown) and a common voltage “Vcom” to be applied to the common electrode, and outputs the grayscale voltage Vgma and the common voltage Vcom to the data driver 230.

The gate driver 220 is controlled by the gate control signal CS1 from the signal controller 210. The gate driver 220 sequentially supplies analog signals including the gate-on voltage Von and the gate-off voltage Voff input from the voltage generator 240 to the individual gate lines G1 to Gn as gate signals.

The data driver 230 is controlled by the data control signal CS2 received from the signal controller 210. The data driver 230 selects a grayscale voltage at a predetermined level corresponding to each of the internal image data R′, G′, and B′ among the plurality of grayscale voltages Vgma, and then applies analog signals including the grayscale voltage at the predetermined level to the data lines D1 to Dm as the data signals. In the liquid crystal display having the above-described configuration, an output frame rate is multiplied and image data of each of multiplied frames is corrected by alternately using a plurality of look up tables having different correction characteristics based on viewing positions of a user. In this way, the user recognizes an average image characteristic from the plurality of screens that provide the optimum image for plural positions, and thereby visibility, in particular, lateral visibility is improved.

A method of driving a liquid crystal display according to an exemplary embodiment of the invention will now be described with reference to FIG. 3. FIG. 3 is a schematic diagram illustrating correction data set alternately applied to respective frames.

The control signal generating unit 212 generates the gate control signal CS1 in response to the external control signal and transmits the gate control signal CS1 to the gate driver 220. Further, the control signal generating unit 212 generates the data control signal CS2 in response to the external control signal, and transmits the data control signal CS2 to the data driver 230. At this time, the gate control signal CS1 and the data control signal CS2 are generated based on higher frame rate, that is, a frame rate twice as high as a typical frame rate. For example, when the liquid crystal display according to the exemplary embodiment is employed in TV, the gate control signal CS1 and the data control signal CS2 are generated based on a frame rate of 120 Hz not on a typical frame rate of 60 Hz. In addition, the control signal generating unit 212 generates the selection signal SS synchronized with the vertical sync start signal STV, by which the respective frames are identified, and transmits the selection signal SS to the memory unit 250.

The memory unit 250 alternately selects the first look up table LUT1 and the second look up table LUT2 according to the selection signal SS from the control signal generating unit 212, and supplies the selected look up table (LUT1 or LUT2) to the image signal processing unit 211. Thus, the first look up table LUT1 is selected and supplied to the image signal processing unit 211 in the Nth frame, and the second look up table LUT2 is selected and supplied to the image signal processing unit 211 in the (N+1)th frame. Here, N is a positive integer.

The image signal processing unit 211 generates an internal image data R′, G′ and B′ by converting input image data R, G and B to digital type, rearranging them according to a pixel arrangement of the liquid crystal display panel 100, and correcting the image characteristics. The image signal processing unit 211 performs image correction on image data R, G and B of a corresponding frame by alternately using the first look up table LUT1 or the second look up table LUT2 supplied from the memory unit 250. That is, the image signal processing unit 211 performs image correction by using the first lookup table LUT1 in the Nth frame, and by using the second lookup table LUT2 in the (N+1)th frame, respectively.

The gate driver 220 sequentially applies the gate signals to the individual gate lines G1 to Gn and turns on the switching element Q of a predetermined gate line G to sequentially select a scan line, to which the data signals are applied.

The data driver 230 sequentially receives the corrected image data R′, G′ and B′ from the signal controller 210, and selects a grayscale voltage at a predetermined level corresponding to each of the corrected image data R′, G′ and B′ among the plurality of grayscale voltages Vgma generated by the voltage generator 240. The data driver 230 then generates data signals and simultaneously applies the data signals corresponding to one row of pixels to the scan line selected by the gate driver 220.

Thus configured, all the pixels in the liquid crystal display panel 100 are charged with the voltages under the control of the driving circuit 200, such that an electric field is generated in the liquid crystal layer. That is, the data signals each having a potential of an appropriate level are applied to the pixel electrodes according to a display grayscale level, and the common voltage Vcom is applied to the common electrode. The electric field is generated between the pixel electrodes and the common electrode. As a result, the alignment of liquid crystal molecules varies, which causes a variation in transmittance of light incident from the rear side of the panel 100. Thereafter, light from a backlight unit (not shown) located at the rear of the liquid crystal display panel 100 passes through the liquid crystal layer, is colored by red, green, and blue color filters on the upper substrate, and is emitted to the front side of the panel 100. Light components emitted from the individual pixels are mixed to display a color image.

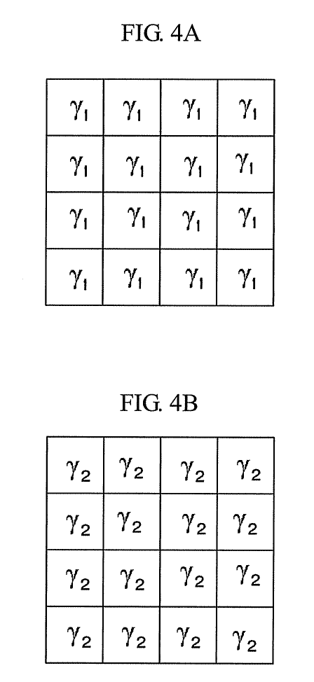

FIGS. 4A and 4B are schematic diagrams illustrating visibility characteristic of an output image in each frame. Referring to FIGS. 4A and 4B, since the frame rate is doubled, two screens having the same image are alternately displayed on the liquid crystal display panel 100 at the same time. A screen corresponding to the Nth frame (FIG. 4A) is corrected by the first look up table LUT1, and has an image characteristic γ1 optimized for the user viewing the screen from the left side. Meanwhile, the screen corresponding to the (N+1)th frame (FIG. 4B) is corrected by the second look up table LUT2, and has an image characteristic γ2 optimized for the user viewing the screen from the right side. Since the two screens are alternately displayed while one screen is displayed in a conventional display, the user recognizes the two screens as a single overlapping screen due to a residual image effect. That is, the user recognizes an average image characteristic of the two screens optimized for the left and right side users respectively. As a result, a screen having a uniform image characteristic is provided to the user regardless of the viewing position, thereby a visibility, in particular, a lateral visibility is improved.

Although the image correction according to the exemplary embodiment is performed for users viewing the screen from the left and right sides of the liquid crystal display panel, the present invention is not limited thereto, and the image correction can be performed for users at plural positions. For example, image correction can be performed for users viewing a screen from upper and lower sides of a liquid crystal display panel, and upper left and lower right sides of the liquid crystal display panel.

The embodiment of the invention has been described while focusing on the liquid crystal display panel of a TN mode, in which the liquid crystal molecules are horizontally aligned. However, the invention is not limited thereto and can be applied to liquid crystal display panels of various modes. That is, the invention can be applied to a liquid crystal display panel of, e.g., a Vertically Aligned “VA” mode, in which the liquid crystal molecules are vertically aligned, a liquid crystal display panel of a Patterned Vertically Aligned “PVA” mode, in which a plurality of cutout patterns are formed in the pixel electrodes or the common electrode, thereby improving the VA mode, such that a plurality of domains are formed in the unit pixel, or a liquid crystal display panel of a Super Patterned Vertically Aligned “SPVA” mode, in which a main pixel and a sub pixel are formed in the unit pixel, thereby improving the PVA mode, such that a plurality of domains are formed.

As described above, according to the exemplary embodiment of the invention, an output frame rate of image signals is multiplied and image data of each of multiplied frames is corrected by alternately applying a plurality of correction data set having different correction characteristics depending on viewing positions of a user with respect to the liquid crystal display.

Accordingly, a plurality of screens corresponding to the multiple is displayed on the liquid crystal display panel. Therefore, the user can recognize the average image characteristic of the plurality of screens that provide the optimum image characteristic for plural positions. As a result, it is possible to solve the problem in visibility, in particular, lateral visibility according to the position of the user.

Although the invention has been described with reference to the accompanying drawings and the preferred embodiments, the invention is not limited thereto, but is defined by the appended claims. Therefore, it should be noted that various changes and modifications may be made by those skilled in the art without departing from the technical spirit and scope of the appended claims.

What is claimed is:

1. A liquid crystal display comprising:
a liquid crystal display panel displaying an image;
a gate driver applying gate signals to the liquid crystal display panel;
a data driver applying data signals to the liquid crystal display panel; and
a signal controller controlling the gate driver and the data driver,
wherein the signal controller comprises a control signal generating unit multiplying a frame rate, and an image signal processing unit correcting image data of each of multiplied frames by alternately using a plurality of correction data set having different correction characteristics.

2. The liquid crystal display of claim 1,
further comprising a memory unit storing the plurality of the correction data set.

3. The liquid crystal display of claim 2,
wherein the correction characteristic of the plurality of correction data set is changed depending on viewing positions of a user with respect to the liquid crystal display.

4. The liquid crystal display of claim 3,
wherein the plurality of correction data set comprises a first look up table including correction data for providing an optimum image for a user viewing the liquid crystal display from the left side, and a second look-up table including correction data for providing an optimum image for a user viewing the liquid crystal display from the right side.

5. The liquid crystal display of claim 4,
wherein the correction data comprises one of adaptive color capture data, dynamic capacitance compensation correction data, gamma compensation data and combinations thereof.

6. The liquid crystal display of claim 4,
wherein the first and the second look up tables are alternately selected in accordance with a selection signal and provided to the image signal processing unit.

7. The liquid crystal display of claim 6,
wherein the selection signal is generated based on a vertical sync start signal generated in the control signal generating unit.

8. The liquid crystal display of claim 1,
wherein the image signal processing unit comprises one of an adaptive color capture circuit, a dynamic capacitance compensation circuit, a gamma compensation circuit and combinations thereof.

9. The liquid crystal display of claim 1,
wherein the control signal generating unit doubles the frame rate from 60 Hz to 120 Hz.

10. A method of driving a liquid crystal display comprising:
multiplying a frame rate to multiply the number of frames;
correcting image data of each of multiplied frames by alternately using a plurality of correction data set having different correction characteristic;
displaying an image by supplying the corrected image data to a liquid crystal display panel.

11. The method of claim 10,
wherein the correction characteristic of the plurality of correction data set is changed depending on viewing positions of a user with respect to the liquid crystal display.

12. The method of claim 11,
wherein the plurality of correction data set comprises a first look up table including correction data for providing an optimum image for a user viewing the liquid crystal display from the left side, and a second look up table including correction data for providing an optimum image for a user viewing the liquid crystal display from the right side.

13. The method of claim 12,
wherein correcting the image data of each of the multiplied frames comprises: correcting the image data using the first look up table in Nth frame; and correcting the image data using the second look up table in (N+1)th frame.

14. The method of claim 10,
wherein the correction of the image data comprises one of an adaptive color capture mode, a dynamic capacitance compensation mode, a gamma compensation mode and combinations thereof.

15. The method of claim 10,
wherein the frame rate is doubled from 60 Hz to 120 Hz.
